(19) United States
(12) Patent Application Publication
(10) Pub. No.: US 2024/0104366 A1
(43) Pub. Date: Mar. 28, 2024

(54) MULTIPLEXED GRAPH NEURAL NETWORKS FOR MULTIMODAL FUSION

(71) Applicant: INTERNATIONAL BUSINESS MACHINES CORPORATION, ARMONK, NY (US)

(72) Inventors: Niharika DSouza, San Jose, CA (US); Tanveer Syeda-Mahmood, Cupertino, CA (US); Andrea Giovannini, Zurich (CH); Antonio Foncubierta Rodriguez, Zurich (CH)

(21) Appl. No.: 17/933,468

(22) Filed: Sep. 19, 2022

(51) Int. Cl. G06N 3/08; G06N 3/04

(52) U.S. Cl. CPC G06N 3/08; G06N 3/04

(57) ABSTRACT

A computer implemented method includes transforming a set of received samples from a set of data into a multiplexed graph, by creating a plurality of planes, each plane having the set of nodes and the set of edges. Each set of edges is associated with a given relation type from the set of relation types. Message passing walks are alternated within and across the plurality of planes of the multiplexed graph using a graph neural network (GNN) layer. The GNN layer has a plurality of units where each unit outputs an aggregation of two parallel sub-units. Sub-units include a typed GNN layer that allows different permutations of connectivity patterns between intra-planar and inter-planar nodes. A task-specific supervision is used to train a set of weights of the GNN for the machine learning task.

### BACKGROUND

### Technical Field

The present disclosure generally relates to Artificial Intelligence, and more particularly, to systems and methods of creating Multiplexed Graph Neural Networks.

### Description of the Related Art

Machine learning algorithms have increased in relevance and applicability in the past few decades. New machines use machine learning algorithms for any of a variety of tasks, usually where data analysis is important, and the algorithm can be improved upon itself. Graphs and connected data are another important area where the state-of-the-art technologies have yet to see significant improvements. Neural networks further have many forms and data types that can go along as inputs to their various kinds of systems.

In many applications, evidence for an event, a finding or an outcome could be distributed across multiple modalities. Data at a single modality, may also be too weak to draw strong enough conclusions. There are no efficient and accurate methods or systems to combine data from various modalities so that machine learning tasks are solved efficiently, and with the least amount of computational effort. Current methods may miss data, compute slowly and not account for various modalities.

Multimodal fusion is increasing in importance for healthcare analytics, for example as well as many other areas. Modalities, may be images, scanning devices, video, sound, databases, etc. Current work on multi-graphs using graph neural networks (GNN) is very limited. Most frameworks separate the graphs resulting from individual edge types, process them independently and then aggregate the representations ad-hoc. Further, systems that consider multiplex-like structures in the message passing either separate within and across relational edges or rely on diffused averaged representations for message passing.

### SUMMARY

According to an embodiment of the present disclosure, a computer-implemented method to solve a machine learning includes receiving a set of data having a set of nodes, a set of edges, and a set of relation types. A set of received samples from the set of data are transformed into a multiplexed graph, by creating a plurality of planes, each having the set of nodes and the set of edges, wherein each set of edges is associated with a given relation type from the set of relation types. Message passing walks are alternated within and across the plurality of planes of the multiplexed graph using a graph neural network (GNN) layer, wherein the GNN layer has a plurality of units and each unit outputs an aggregation of two parallel sub-units, and each sub-unit of the two parallel sub-units comprises a typed GNN layer that allows different permutations of connectivity patterns between intra-planar and inter-planar nodes. A task-specific supervision is used to train a set of weights of the GNN for the machine learning task. The method has the technical effect of increasing efficiency and accuracy of system computations on data used in multi-modal systems.

In one embodiment, for each sub-unit, a respective supra-walk matrix dictates that a set of information from the message passing walks is exchanged first within a planar connection followed by across a planar connection or vice-versa. This allows more accurate modeling.

In one embodiment, the machine learning task is a prediction of a graph level, an edge-level, and/or a node-level label of the set of provided samples. This enables greater accuracy of data manipulation.

In one embodiment, the aggregation of the sub-units is solved by a concatenation. This enables greater accuracy of data manipulation.

In one embodiment, the aggregation of the sub-units is solved by at least one of a minimum, a maximum, and/or an average. This enables greater accuracy of data manipulation.

In one embodiment, the GNN is one of a graph isomorphism network (GIN), a graph convolutional network (GCN), or a partial neighborhood aggregation network (PNA). This allows more efficient computational resource usage.

In one embodiment, the units are arranged serially in cascade. This allows more efficient computing capabilities.

According to an embodiment of the present disclosure a non-transitory computer readable storage medium tangibly embodying a computer readable program code having computer readable instructions to solve a machine learning task is provided. The code may include instructions for receiving a set of data having a set of nodes, a set of edges, and a set of relation types. The instructions may further transform a set of provided samples from the set of data into a multiplexed graph, by creating a plurality of planes that each have the set of nodes and the set of edges, wherein each set of edges is associated with a given relation type from the set of relation types. The instructions may also initiate alternating message passing walks within and across the plurality of planes of the multiplexed graph using a graph neural network (GNN) layer, wherein, the GNN layer has a plurality of units, each unit of the plurality of units outputs an aggregation of two parallel sub-units and sub-units of the plurality of units comprise a typed GNN layer that allows different permutations of connectivity patterns between intra-planar and inter-planar nodes. Further the instructions may include using a task-specific supervision to train a set of weights of the GNN for the machine learning task. The method may increase efficiency and accuracy of system computations on data used in multi-modal systems.

In one embodiment, the instructions include for each sub-unit, a respective supra-walk matrix dictating that a set of information from the message passing walks is exchanged first within a planar connection followed by across a planar connection or vice-versa. This allows more accurate modeling.

In one embodiment, the machine learning task is a prediction of a graph level, an edge-level, and a node-level label of the set of provided samples. This enables greater accuracy of data manipulation.

In one embodiment, the instructions include the aggregation of the sub-units is solved by a concatenation. This enables greater accuracy of data manipulation.

In one embodiment, the instructions include the aggregation of the sub-units is solved by at least one of a minimum, a maximum and/or an average. This enables greater accuracy of data manipulation.

In one embodiment, the GNN is one of a graph isomorphism network (GIN), a graph convolutional network (GCN), or a partial neighborhood aggregation network (PNA). This allows more efficient computational resource usage.

In one embodiment, the units are arranged serially in cascade. This allows more efficient computing capabilities.

According to an embodiment of the present disclosure a computing device including a processor, a network interface coupled to the processor to enable communication over a network, a storage device coupled to the processor; and instructions stored in the storage device, wherein execution of the instructions by the processor configures the computing device to perform a method of solving a machine learning task. The method may include receiving a set of data with a set of nodes, a set of edges, and a set of relation types. A set of received samples are transformed from the set of data into a multiplexed graph, by creating a plurality of planes, each having the set of nodes and the set of edges, wherein each set of edges is associated with a given relation type from the set of relation types. Message passing walks are alternated within and across the plurality of planes of the multiplexed graph using a graph neural network (GNN) layer, wherein the GNN layer has a plurality of units and each unit outputs an aggregation of two parallel sub-units, and each sub-unit of the two parallel sub-units comprises a typed GNN layer that allows different permutations of connectivity patterns between intra-planar and inter-planar nodes. The method also includes using a task-specific supervision to train a set of weights of the GNN for the machine learning task. The method may increase efficiency and accuracy of system computations on data used in multi-modal systems.

In one embodiment, for each sub-unit a respective supra-walk matrix dictates that a set of information from the message passing walks is exchanged first within a planar connection followed by across a planar connection or vice-versa. This allows more accurate modeling.

In one embodiment, the machine learning task is a prediction of a graph level, an edge-level, and a node-level label of the set of provided samples. This enables greater accuracy of data manipulation.

In one embodiment, the aggregation of the sub-units is solved by a concatenation. This enables greater accuracy of data manipulation.

In one embodiment, the aggregation of the sub-units is solved by at least one of a minimum, a maximum and/or an average. This enables greater accuracy of data manipulation.

In one embodiment, the GNN is one of a graph isomorphism network (GIN), a graph convolutional network (GCN), or a partial neighborhood aggregation network (PNA). This allows more efficient computational resource usage.

The techniques described herein may be implemented in a number of ways. Example implementations are provided below with reference to the following figures.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 illustrates an example architecture for implementing Multiplexed Graph Neural Networks using multiplexed graph data according to an embodiment.

FIG. 2 illustrates an example Graph Convolutional Network according to an embodiment.

FIG. 3 illustrates an example Graph Convolutional Network Message Passing Scheme according to an embodiment.

FIG. 4 illustrates an example method for implementing Multiplexed Graph Neural Networks using multiplexed graph data according to an embodiment.

FIG. 5 illustrates implementations of processes according to an embodiment.

FIG. 6 illustrates equations and formulas used in creation of the message passing and backpropagation.

FIG. 7 illustrates the experimental results 700.

FIG. 8 is a functional block diagram illustration of a computer hardware platform that can communicate with various networked components.

FIG. 9 depicts a cloud computing environment, consistent with an illustrative embodiment.

FIG. 10 depicts abstraction model layers, consistent with an illustrative embodiment.

### DETAILED DESCRIPTION

### Overview

In the following detailed description, numerous specific details are set forth by way of examples to provide a thorough understanding of the relevant teachings. However, it should be apparent that the present teachings may be practiced without such details. In other instances, well-known methods, procedures, components, and/or circuitry have been described at a relatively high-level, without detail, to avoid unnecessarily obscuring aspects of the present teachings.

The present disclosure generally relates to systems and methods of creating and using multiplexed Graph Neural Networks (GNN). Some embodiments may use the multiplexed GNN for multimodal fusion. The systems are able to model multiple aspects of connectivity for any given problem. For example, during fusion from multiple sources, systems may handle different sources of connectivity between entities. For example, typical uses include social media and brain connectomics. The nodes of the graph in a multiplex graph may be structured in such a way that they are divided up across planes such that the same nodes are repeated across planes. The plane may represent, one relational aspect between nodes and within each plane there may be interconnections between the corresponding nodes. Across planes, there may be connections between the same copies of nodes. Current systems present insufficient learning representations of graphs with different types of connectivity or where there is more than one type of relational aspect.

Some embodiments include multiplex GNN which use one or more message passing schemes. The message passing scheme may be capable of systematically integrating complimentary information across different relational aspects. One example multiplex GNN may be used on a semi-supervised node classification task. Another example multiplex GNN includes a domain specific multiple fusion in comparison to several baselines.

Some graphs may have one type of node and one type of edge, where a node could represent features from different modalities, and the edges could capture different dependencies within features of data analysis. Graph neural networks map the input graph and the graph signal to an output, and at the same time, make use of the intrinsic connectivity in the graph and filter the signal by tracking the information flow based on local neighborhoods. To be able to do this, a message passing scheme may be used, in some embodiments, which can map from the input graph signal to the output. For message passing, some graph neural networks make use of an adjacency matrix that can compactly represent this kind of message passing information. As more and more hidden layers are composed, a server such as an analytics service server can go further and further into the graph. These operations may be applied in cascade. For neighbors at a given node, a filtering operation may be performed to infer the new hidden representation at the node of interest. The filtering operation may be accomplished by a form of basic neighborhood aggregation. When one aggregates information from across local neighborhoods and cascades more than one such layer, say L layers, then the aggregation may be considered equivalent to exploring paths of length L between these nodes and due to the properties of its adjacency matrix.

In one example using multiple test modalities, a complex disease like cancer may be considered. Evidence for cancer may be present in multiple modalities such as clinical, genomic, molecular, pathological and radiological imaging. In achieving true scene understanding in computer vision, data from audio, video and sensor data may all prefer to be fused. In each of these examples, multimodal fusion may be used due to evidence of an entity, such as an event, or a disease may be present in more than one modality, where no single modality may be sufficient to create strong enough conclusions. Fusing the data may be difficult though because some sources may be complimentary while others are contradictory. In some embodiments, modality features may be mutually exclusive, mutually correlated, or mutually reinforcing. In some examples, one modality may be confirmatory, causing others to become redundant. Also, all modalities may not be present for a sample, and the present ones may be error-prone or spurious.

Accordingly, one or more of the methodologies discussed herein may obviate a need for time consuming data processing by the user. This may have the technical effect of enhanced computing with greater, faster and more accurate results.

It should be appreciated that aspects of the teachings herein are beyond the capability of a human mind. It should also be appreciated that the various embodiments of the subject disclosure described herein can include information that is impossible to obtain manually by an entity, such as a human user. For example, the type, amount, and/or variety of information included in performing the process discussed herein using multiplexed GNN's can be more complex than information that could be reasonably be processed manually by a human user.

### Example Architecture

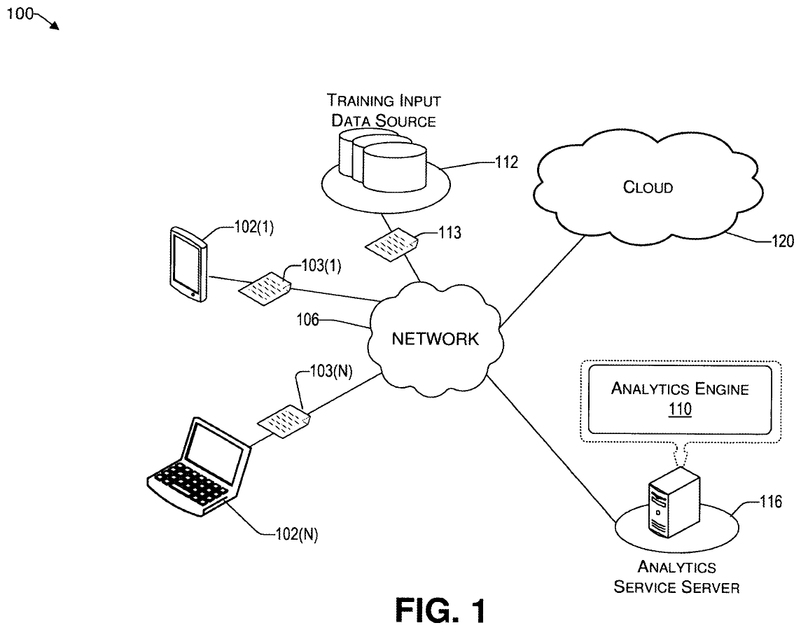

To better understand the features of the present disclosure, it may be helpful to discuss known architectures. To that end, FIG. 1 illustrates an example architecture 100 for implementing Multiplexed Graph Neural Networks using multiplexed graph data according to some embodiments. Architecture 100 includes a network 106 that allows various computing devices 102(1) to 102(N) to communicate with each other, as well as other elements that are connected to the network 106, such as a training data source 112, an analytics service server 116, and the cloud 120.

The network 106 may be, without limitation, a local area network (“LAN”), a virtual private network (“VPN”), a cellular network, the Internet, or a combination thereof. For example, the network 106 may include a mobile network that is communicatively coupled to a private network, sometimes referred to as an intranet that provides various ancillary services, such as communication with various application stores, libraries, and the Internet. The network 106 allows the analytics engine 110, which is a software program running on the analytics service server 116, to communicate with a training data source 112, computing devices 102(1) to 102(N), and the cloud 120, to provide machine learning capabilities. In one embodiment, the data processing is performed at least in part on the cloud 120.

For purposes of later discussion, several user devices appear in the drawing, to represent some examples of the computing devices that may be the source of data or graphs for the Graph Neural Network (GNN). Aspects of the Multiplexed Graph data (e.g., 103(1) and 103(N)) may be communicated over the network 106 with an analytics engine 110 of the analytics service server 116. Today, user devices typically take the form of portable handsets, smart-phones, tablet computers, personal digital assistants (PDAs), and smart watches, although they may be implemented in other form factors, including consumer, and business electronic devices.

For example, a computing device (e.g., 102(N)) may send a request 103(N) to the analytics engine 110 to perform machine learning on the Multiplexed Graph data stored in the computing device 102(N). In some embodiments, there is (one or more) training data source 112 that is configured to provide training data to the analytics engine 110. In other embodiments, the Multiplexed Graph data are generated by the analytics service server 116 and/or by the cloud 120 in response to a trigger event.

While the training data source 112 and the analytics engine 110 are illustrated by way of example to be on different platforms, it will be understood that in various embodiments, the training data source 112 and the learning server may be combined. In other embodiments, these computing platforms may be implemented by virtual computing devices in the form of virtual machines or software containers that are hosted in a cloud 120, thereby providing an elastic architecture for processing and storage.

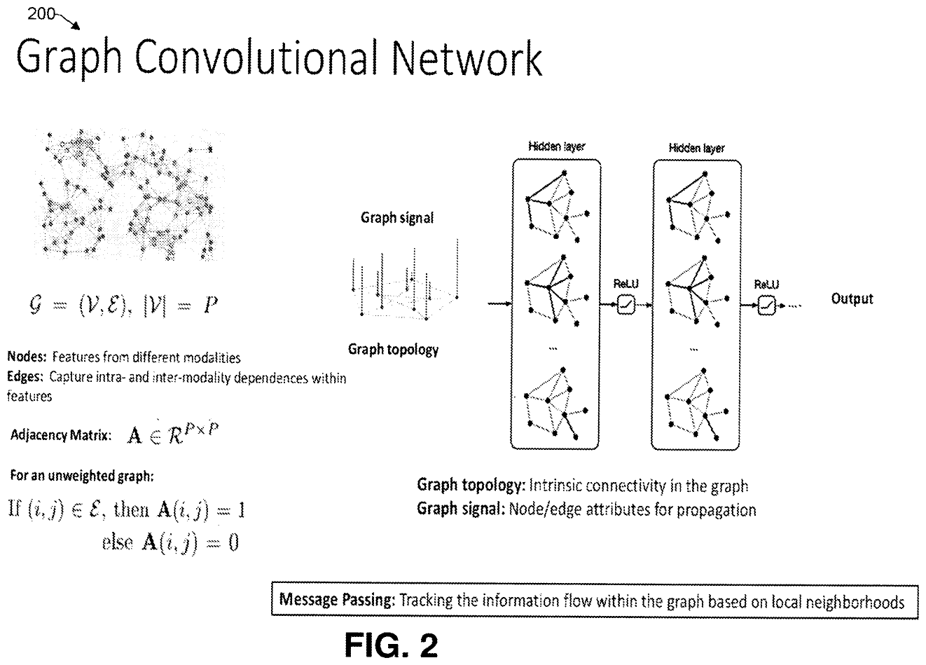

FIG. 2 illustrates an example Graph Convolutional Network 200 according to an embodiment. As illustrated in FIG. 2, nodes of a Graph Convolutional Network (GCN) may be features from different modalities. Similarly, edges may be intra-modality and inter-modality dependencies with the features which are captured in the dataset.

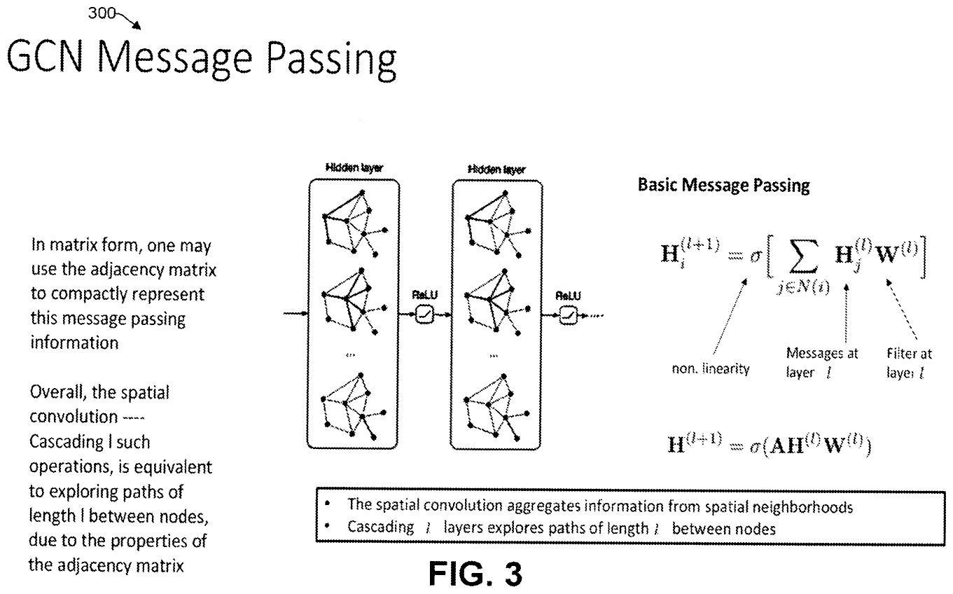

FIG. 3 illustrates an example Graph Convolutional Network Message Passing Scheme 300 according to an embodiment. The GCN Message Passing Scheme 300 may use basic message passing as illustrated with non-linearity, taking account of messages at layer, L and filters at layer L.

### Example Process

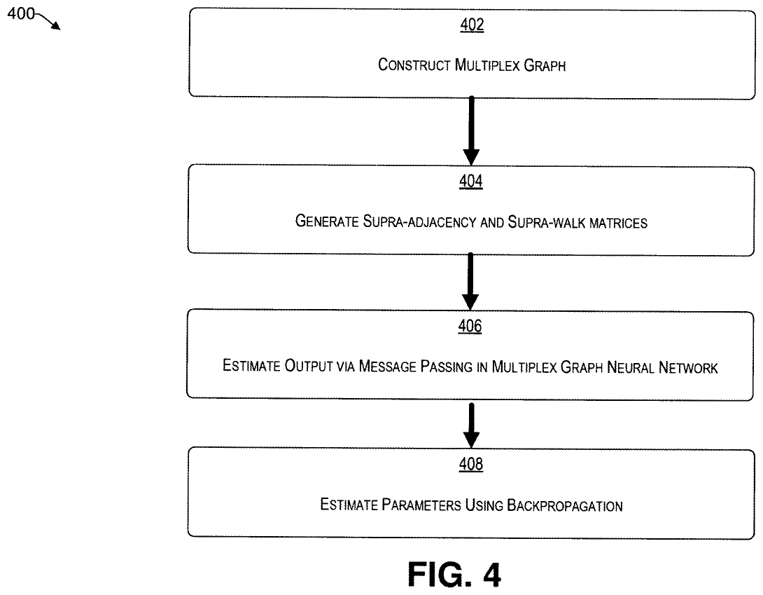

With the foregoing overview of the example architecture 100, and Graph Convolution Networks 200 and 300, it may be helpful now to consider a high-level discussion of example processes. To that end, FIG. 4 presents an example process 400 for implementing Multiplexed Graph Neural Networks using multiplexed graph data according to an embodiment, consistent with an illustrative embodiment. Process 400 is illustrated as a collection of processes in a logical flowchart, wherein each represents a sequence of operations that can be implemented in hardware, software, or a combination thereof. In the context of software, the processes represent computer-executable instructions that, when executed by one or more processors, perform the recited operations. Generally, computer-executable instructions may include routines, programs, objects, components, data structures, and the like that perform functions or implement abstract data types. The order in which the operations are described is not intended to be construed as a limitation, and any number of the described processes can be combined in any order and/or performed in parallel to implement the process. For discussion purposes, the process 400 is described with reference to the architecture 100 of FIG. 1.

At block 402, the analytics service server 116 may start constructs one or more multiplex graphs. Some embodiments can model multiple aspects of connectivity and/or multiple aspects of a given problem. For example, during fusion from multiple sources, one may try to solve a machine learning task given a set of data with one or more set(s) of nodes, one or more set(s) of edges, and one or more set(s) of relation types.

During multiplex graph construction, the inputs are the nodes on the graphs and the material edges received from the input. The output may be a multiplex graph within the nodes, where the different edge types define one plane, giving rise to intra-planar connections and vertical connections also present across planes.

The multiplexed graph may be also created by transforming a set of samples from one or more data sets and creating a plurality of planes, each with the set of nodes and set of edges associated with relation type from the set of data.

At block 404, the analytics service server 116 generates supra-adjacency matrices and/or supra-walk matrices according to methods discussed herein. With the information created at block 404, super-adjacency and supra-walk matrices may be inferred and generated for message passing.

At block 406, the analytics service server 116 estimates the output via message passing in the Multiplexed GNN. The defined message passing is used for aggregation across the graph to map from the input multiplex graph to the output. This may be considered a forward pass through the GNN.

At block 408, the analytics service server 116 estimates the parameters and update them of the Multiplex GNN using backpropagation or other techniques.

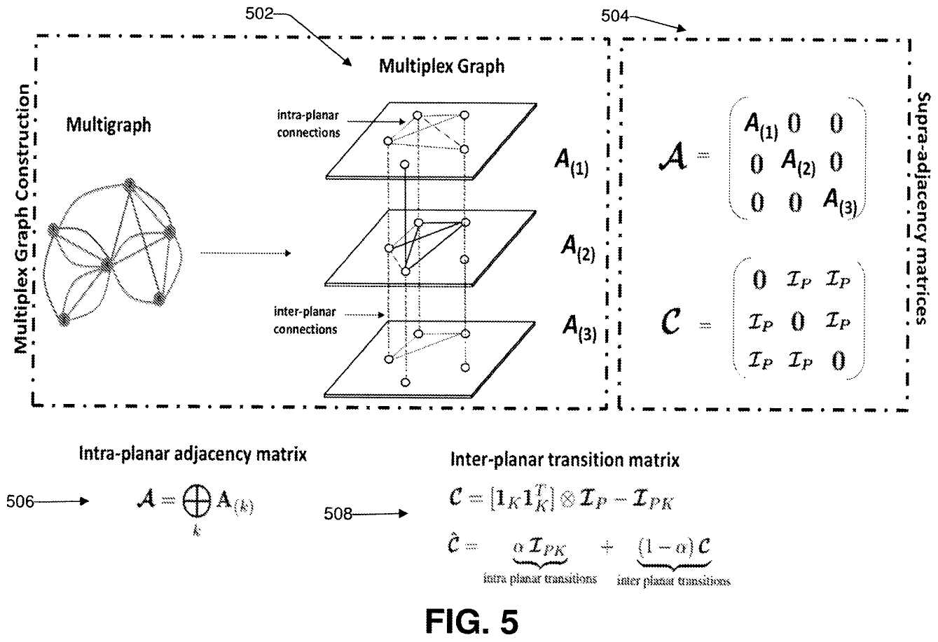

FIG. 5 illustrates implementations of processes according to blocks 402 and 404 according to an embodiment. Multiplex graph 502 is an example of a constructed multiplex graph according to block 402. Additionally, supra-adjacency matrices 504 are an example of matrices generated according to block 404. Formula 506 may be used as an equation for intra-planar adjacency matrix and formula 508 may be used as an equation to generate the inter-planar transition matrix, (see discussion of formulas 2 and 3 below).

### MplexGNN: The Multiplexed Graph Neural Network Formulation—Graph Neural Network

In some embodiments, a monoplex graph may be defined as [symbol] =( [symbol] , ε) with a vertex set [symbol] with number of nodes as |<|=P. The set ε={(i,j) ∈ [symbol] × [symbol] may denote the edges linking pairs of nodes i and j. These relationships may be captured as an adjacency matrix A∈ [symbol] ^{P×P}. In the simplest case, the elements of this matrix may be binary A[i, j]=1 if (i,j)∈ε and zero otherwise. More generally, A[i, j] ∈[0,1], may indicate the strength of connectivity between nodes i and j. A typical GNN schema may include a message passing scheme for propagating information across the graph, as well as task-specific supervision to guide the representation learning.

Each node i of the input graph g may have a fixed input feature descriptor xᵢ∈ [symbol] ^{D×1} associated with it. The message passing scheme may ascribe a set of mathematical operations occurring at each layer l∈{1, . . . , L} of the GNN. Let hᵢ^{(l)}∈ [symbol] ^{D}^{^{l}}^{×1} be node feature for node i at layer (l). GNNs may infer the representations at subsequent layers (l+1) by aggregating representations ({hⱼ^{(l)}}) of nodes j that it is connected to i. One may also express these node embeddings compactly as a matrix H^{(l)}∈ [symbol] ^{|V|×D}^{^{l}}, where H^{(l)}[j, [symbol] ]=hⱼ^{(l)}.

The input layer (l), may have, for example:

hᵢ^{(l+1)}=ϕ({hⱼ^{(l)}},A;θ^{(l)}) where j:(i,j)∈ε (1).

where ϕ(⋅): [symbol] ^{D}^{^{l}}→ [symbol] D^{(l+1)} is an aggregation function, and θ^{(l)} denotes learnable parameters for layer l. hᵢ⁽⁰⁾=xᵢ at the input. From here, the node embeddings may be used to estimate the outputs of the GNN via a mapping f₀:Ŷ=f₀({hᵢ^{L}}). Depending on the task, the targets Y may provide either graph, edge, or node level supervision during training. The parameters of the GNN are then estimated by optimizing a loss function [symbol] (Y, Ŷ) via back-propagation for gradient estimation.

### MplexGNN: The Multiplexed Graph Neural Network Formulation—the Multiplex Graph

In a multigraph [symbol] _{M}=( [symbol] , ε_{M}), K distinct types of edges can link two nodes. Formally, ε_{M}={(i, j)∈ [symbol] × [symbol] ,k∈{1, . . . , K}}. Analogously, one may define k such adjacency matrices A₍ₖ₎∈ [symbol] ^{P×P} corresponding to the connectivity information in the edge-type k. The multiplexed graph may be a type of multigraph in which the nodes are grouped into planes representing each edge-type according to some embodiments. Formally, let [symbol] _{Mplex}=( [symbol] _{Mplex}, ε_{Mplex}) be the multiplex graph, where | [symbol] _{Mplex}|=| [symbol] |×K and ε_{Mplex}={(i,j)∈ [symbol] _{Mplex}× [symbol] _{Mplex}}. The multiplex graph construction is illustrated in FIG. 5. Since the nodes [symbol] _{Mplex} of the multiplex graph are produced by creating copies of nodes across the planes, they may be referred to as supra-nodes. Within each plane, one may connect supra-nodes to each other via the adjacency matrix A₍ₖ₎ These intra-planar connections allow one to traverse across the multi-graph according to individual relational edge-types. The information captured within a plane may be multiplexed to other planes through vertical connections, thus connecting each supra-node with its own copy in other planes. These connections allow one to traverse across the planes and exploit cross-relational dependencies in tandem with in-plane traversal.

### The Multiplex Walk Formalism

Walks on the multiplex [symbol] _{Mplex} may be formalized using two key quantities: an intra-planar adjacency and an inter-planar transition matrix [symbol] ∈ [symbol] ^{PK×PK}, and an inter-planar transition matrix [symbol] ∈ [symbol] ^{PK×PK} Referring to FIG. 5:

$$\\ \begin{matrix}𝒜 = {⊕}_{k} {A}_{( k )} ; 𝒞 = [ {1}_{K} {1}_{K}^{T} ] ⊗ {𝒥}_{P} - {𝒥}_{PK} & ( 2 )\end{matrix}$$

where

$$\\ {⊕}_{k}$$

is the direct sum operation, ⊗ denotes the Kronecker product, 1_{K} is the K vector of all ones, and ιₚ denotes the identity matrix of size P×P. Thus [symbol] is block-diagonal by construction and captures within plane transitions across supra-nodes. On the other hand, [symbol] has 0 s in the corresponding block diagonal locations, and identity matrices along off-diagonal blocks. This may limit across plane transitions to be between supra-nodes that arise from the same multi-graph node. Thus edges are present between supra-nodes i and P(k−1)+i for k∈{1, . . . , K}. From a traversal standpoint, this is not too restrictive since supra-nodes across planes may already be reached by combining within and across-planar transitions. Moreover, this reduces the computational complexity by making the multiplex graph sparse ( [symbol] (PK) inter-planar edges instead of [symbol] (P²K)).

A walk on [symbol] _{Mplex} allows one to start from a given supra-node i∈ [symbol] _{Mplex} and reach any another supra-node j∈ [symbol] _{Mplex}. This may be achieved by combining within and across planar transitions. To this end, one may utilize a coupling matrix [symbol] derived from [symbol] as:

$$\\ \begin{matrix}\hat{𝒞} = {\underbrace{α {𝒥}_{PK}}}_{intraplanartransitions} + {\underbrace{( 1 - α ) 𝒞}}_{interplanartransitions} & ( 3 )\end{matrix}$$

Here, α∈[0,1] controls the relative frequency of taking the two types of transitions, and may be user specified, or can be learned implicitly. In the extremes, α=0 restricts intra-planar transitions, while α=1 disallows inter-planar transitions.

Going one step further, one may allow [symbol] to assign variable relative weights for transitions across pairs of planes. Mathematically, this may be achieved by replacing the scalar weighting α by an intra-planar weight vector α∈ [symbol] ^{K×1}. Similarly, in lieu of the (1−α) term, there is a cross planar transition weighting β∈ [symbol] ^{K×K} such that β1+α=1_{K} and βₖₖ=0 ∀k∈{1, . . . , K}. Effectively, [symbol] =ιₚ⊗α+ιₚ⊗β.

Thus [symbol] and [symbol] in some embodiments, allow one to define multi-hop transitions on the multiplex in a convenient factorized form. Based on these principles, a multiplex walk may be defined on the supra-nodes according to the following transition guidelines. A (supra)-transition may be a single intra-planar step, or a step that includes both an inter-planar step moving from one plane to another (this may be before or after the occurrence of an intra-planar step). The latter type of transition may not allow two consecutive inter-planar steps (which would be 2-hop neighbourhoods).

Since each of the planar relation-specific edges offer complementary information, the inter-planar and intra-planar edges distinguish between the action of transitioning across planes from transitioning between individual nodes. One may utilize the foundational principles of supra-walk matrices to make this distinction. The supra-walk matrix defined as [symbol] captures transitions where after an intra-planar step, the walk may continue in the same plane or transition to a different plane (Type I). Similarly, [symbol] refers to the case where the walk can continue in the same plane or transition to a different plane before an intra-planar step (Type II).

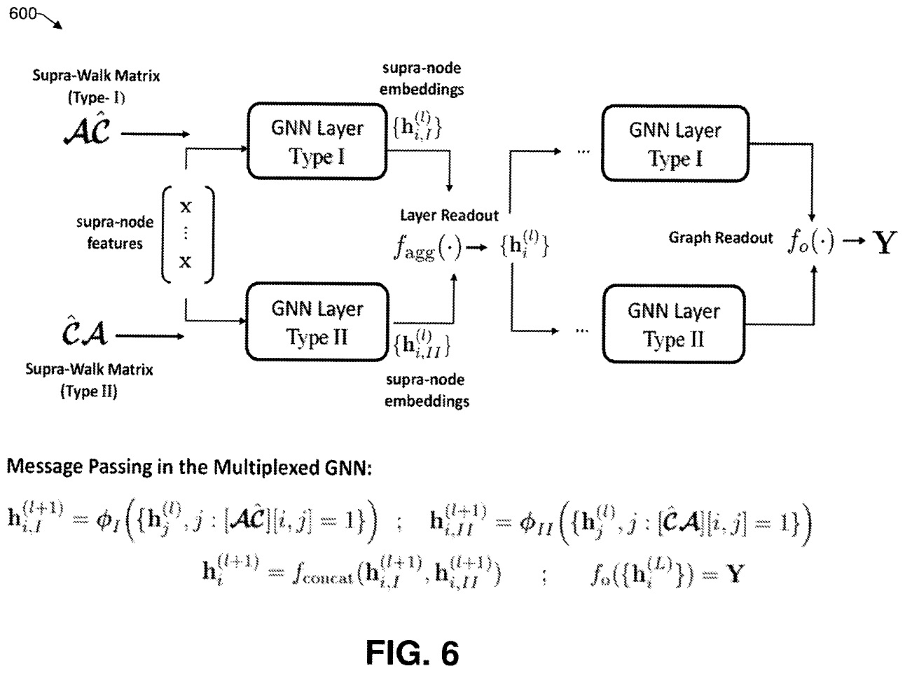

FIG. 6 illustrates equations and formulas used in creation of the message passing done in block 406 and detailed below, and the backpropagation performed in block 408.

### The Multiplexed Graph Neural Network Formulation—Message Passing in the MplexGNN

The supra-walk matrices perform an analogous role to adjacency matrices in monoplex graphs to keep track of path traversals. Therefore, these matrices are good candidates for deriving message passing (Eq. (1)) in the Mplex GNN.

In monoplex graphs, A and its matrix powers allow one to keep track of neighborhoods (at arbitrary l hop distance) during message passing. ϕ(⋅) in Eq. (1) performs a pooling across such neighbourhoods. Conceptually, cascading l GNN layers is analogous to pooling information at each node i from its l-hop neighbors that can be reached by a walk starting at i. Referring to Theorem 1 from Chapter 1 in [3], when α=0.5 (Eq. (3)), the total number of paths of length l between supra nodes i and j on the multiplex are given by the quantity ( [symbol] )^{l}[i,j]+( [symbol] )^{l}[i,j]. Therefore, one can use the two supra-walk matrices [symbol] and [symbol] together to define layer-wise MplexGNN message passing operations. Cascading l such layers will pool information at a given supra-node i from all possible l hop neighbors in the multiplex.

Using the same notation as before, hᵢ^{l}∈ [symbol] ^{D}^{^{l}}^{×1} refers to the (supra)-node representation for (supra)-node i. In matrix form, one may write H^{(l)}531 [symbol] ^{Mplex|×D}^{^{l}}, with H^{(l)}[i, :]=hᵢ^{(l)}. One may then compute this via the following operations:

h_{i,I}^{(l+1)}=ϕ({hⱼ^{(l)}}, [symbol] :θ_{I}^{(l)}) where j:[ [symbol] ][i,j]=1

h_{i,II}^{(l+1)}=ϕ({hⱼ^{(l)}}, [symbol] :θ_{II}^{(l)}) where j:[ [symbol] ][i,j]=1

hᵢ^{(l+1)}=f_{agg}h_{i,j}^{(l+1)},h_{i,II}^{(l+1)}) (4)

Here, f_{agg}(⋅) is an aggregation function which combines representations of type I and II, for example by concatenation. θ_{I}^{(l)} and θ_{II}^{(l)} are the learnable neural network parameters at layer l. At the input layer, one has H⁽⁰⁾=X⊗1_{K}, where X∈ [symbol] ^{|V|×D} are the node inputs. As before, ϕ(⋅) performs message passing according to the neighbourhood relationships given by the supra-walk matrices. The message passing operation is illustrated in FIG. 6.

One may define ϕ(⋅) using any standard GNN layer providing added flexibility to control the expressive power. The MplexGNN uses a mapping fₒ(⋅) to map the supra node embeddings {hᵢ^{(L)}} to the task-specific outputs Y at the required granularity (node-level, graph-level, edge-level). The GNN parameters may then be estimated via backpropagation based on the task supervision.

### Experimental Results

Experiments were conducted using Tuberculosis data including 3051 patients, with five classes of treatment outcomes (on treatment, passed away, cured, completed treatment, or failure). Five modalities were used including demographic, clinical, regimen and genomic data for each patient, and chest CTs for 1015 patients. For clinical and regimen data, information that might be directly related to treatment outcomes, such as type of resistance, were removed. For each CT, lung was segmented using multi-atlas segmentation. A pre-trained dense convolutional neural network was then applied to extract a feature vector of 1024-dimension for each axial slice intersecting lung. To aggregate the information from the lung intersecting slices, the mean and maximum of each of the 1024 features were used providing a total of 2048 features. For genomic data from the causative organisms Mycobacterium tuberculosis (Mtb), 81 single nucleotide polymorphisms (SNPs) in genes known to be related to drug resistance were used. In addition, the raw genome sequence was retrieved for 275 patients to describe the biological sequences of the disease-causing pathogen at a finer granularity. The data was processed by a genomics platform. Briefly, each Mtb genome underwent an iterative de novo assembly process and then processed to yield gene and protein sequences. The protein sequences were then processed to generate the functional domains. Functional domains include sub-sequences located within the protein's amino acid chain. The functional domains are responsible for the enzymatic bioactivity of a protein and can more aptly describe the protein's function. 4000 functional features were generated for each patient.

Multiplexed Graph Construction: The regimen and genomic data are categorical features. CT features were continuous. The demographic and clinical data were a mixture of categorical and continuous features. Grouping the continuous demographic and clinical variables together yielded a total of six source modalities. The missing CT and functional genomic features were imputed using the mean values from the training set. To reduce the redundancy in each domain, denoising autoencoder's (d-AE) were used with fully connected layers, LeakyReLU non-linearities and tied weights trained to reconstruct the raw modality features. The d-AE bottleneck was chosen via the validation set. The reduced individual modality features were concatenated to form the node feature vector x. To form the multiplexed graph planes, the contractive autoencoder (c-AE) projects x to a ‘conceptual’ latent space of dimension K<<P where P=128+64+8+128+64+4=396. The c-AE concept space were used to form the planes of the multiplex and explore the correlation between pairs of features. The c-AE architecture mirrors the d-AE, but projects the training examples {x} to K=32 concepts. Within plane connectivity was inferred along each concept perturbing the features and recording those features giving rise to largest incremental responses. Let [symbol] ε_{enc}(⋅): [symbol] ^{P}→ [symbol] ^{K} be the c-AE mapping to the concept space. Let \hat{x}⁽ⁱ⁾ denote the perturbation of the input by setting \hat{x}⁽ⁱ⁾[j]=x[j]∀j≠i and 0 for j=i. Then for concept axis k, the perturbations are pₖ[i]=| [symbol] ε_{enc}(\hat{x}⁽ⁱ⁾)|−| [symbol] ε_{enc}(x)|. Thresholding pₖ∈ [symbol] ^{P×1} selects feature nodes with the strongest responses along concept k. To encourage sparsity, the top one percent of salient patterns was retained. All pairs of such feature nodes were connected with edge-type k via a fully connected (complete) subgraph between nodes thus selected. Across the K concepts, different sets of features were expected to be prominent. The input features x are one dimensional node embeddings (or the messages at input layer l=0). The latent concepts K, and the feature selection (sparsity) are key quantities that control generalization.

Four multimodal fusion approaches were compared:

No Fusion: This baseline utilized a two layered multilayer perceptron (MLP) (hidden width: 400 and 20, LeakyReLU activation) on the individual modality features before the d-AE dimensionality reduction. This provided a benchmark for the outcome prediction performance of each modality separately.

Early Fusion: Individual modalities were concatenated before dimensionality reduction and fed through the same MLP architecture as described above.

Intermediate Fusion: Intermediate fusion was performed after the d-AE projection by using the concatenated feature x as input to a two layered MLP (hidden width: 150 and 20, LeakyReLU activation).

Late Fusion: The late fusion framework was utilized to combine the predictions from the modalities trained individually in the No Fusion baseline. This framework leverages the uncertainty in the 6 individual classifiers to improve the robustness of outcome prediction.

Relational GCN on a Multiplexed Graph: This baseline utilizes the multigraph representation learning but replaces the Multiplex GNN feature extraction with a Relational GCN framework. At each GNN layer, the RGCN runs K separate message passing operations on the planes of the multigraph and then aggregates the messages post-hoc. Since the width, depth and graph readout is the same as with the Multiplex GNN, this helped evaluate the expressive power of the walk-based message passing.

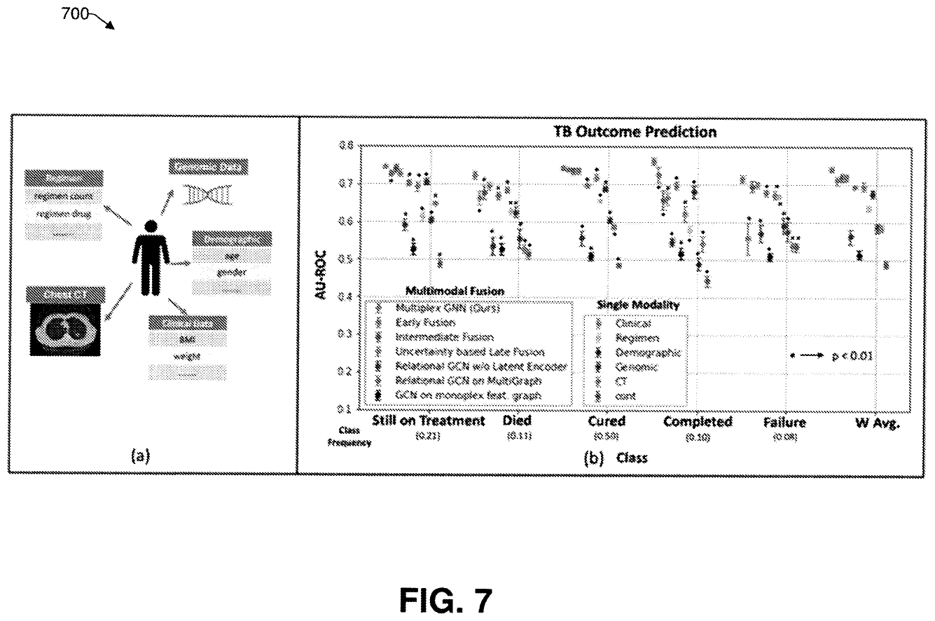

Relational GCN without Latent Encoder: For this comparison, the reduced features were utilized after the d-AE, but instead created a multi-layered graph with the individual modalities in different planes. Within each plane, nodes were fully connected to each other after which a two layered RGCN model was trained. Within modality feature dependence may still be captured in the planes, but the concept space was not used to infer the cross-modal interactions. GCN on monoplex feature graph: This baseline also incorporates a graph-based representation but does not include the use of latent concepts to model within and cross-modal feature correlations. A fully connected graph was constructed on x instead of using the (multi-) conceptual c-AE space and train a two layered Graph Convolutional Network for outcome prediction. FIG. 7 illustrates the experimental results 700.

### Example Computer Platform

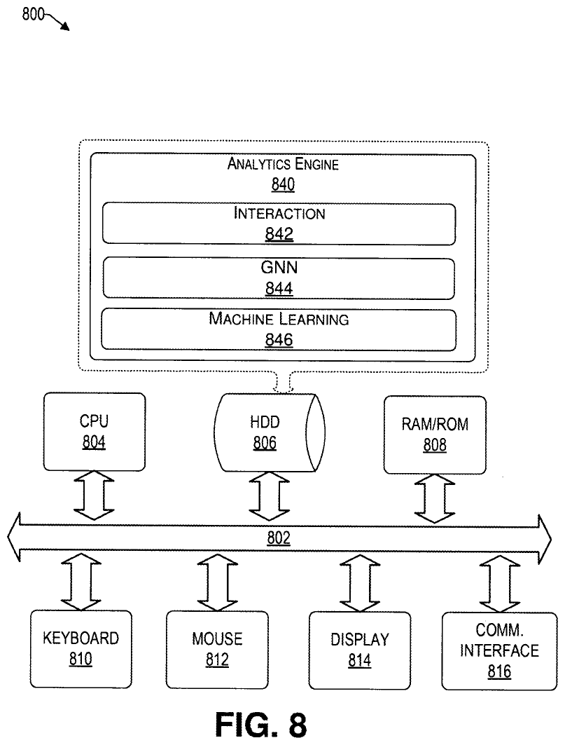

As discussed above, functions relating to a machine learning using multiplexed GNN's can be performed with the use of one or more computing devices connected for data communication via wireless or wired communication, as shown in FIG. 1. FIG. 8 is a functional block diagram illustration of a computer hardware platform that can communicate with various networked components, such as a training input data source, the cloud, etc. In particular, FIG. 8 illustrates a network or host computer platform 800, as may be used to implement a server, such as the analytics service server 116 of FIG. 1.

The computer platform 800 may include a central processing unit (CPU) 804, a hard disk drive (HDD) 806, random access memory (RAM) and/or read only memory (ROM) 808, a keyboard 810, a mouse 812, a display 814, and a communication interface 816, which are connected to a system bus 802.

In one embodiment, the HDD 806, has capabilities that include storing a program that can execute various processes, such as the analytics engine 840, in a manner described herein. The analytics engine 840 may have various modules configured to perform different functions. For example, there may be an interaction module 842 that is operative to interact with one or more computing devices to receive data, such as graph data, nodes, and features. The interaction module 842 may also be operative to receive training data from a training data source.

In one embodiment, there is a GNN module 844. The GNN module may generate one or more multiplexed GNN's based on the data as input. The data may be from multiple modalities, like images, videos, sound recordings, Medical Records, etc.

In one embodiment, there is a machine learning module 846 operative to perform one or more machine learning techniques, such as support vector machine (SVM), logistic regression, neural networks, and the like, on the determined feature matrix.

In one embodiment, the HDD 806 can store an executing application that includes one or more library software modules, such as those for the Java™ Runtime Environment program for realizing a JVM (Java™ virtual machine).

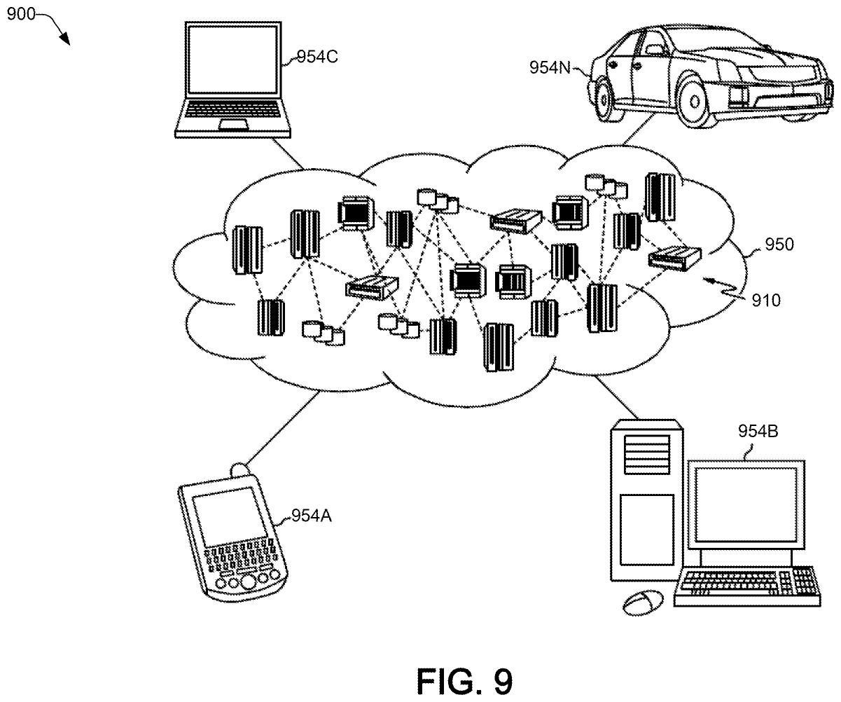

Referring now to FIG. 9, an illustrative cloud computing environment 900 is depicted. As shown, cloud computing environment 900 includes one or more cloud computing nodes 910 with which local computing devices used by cloud consumers, such as, for example, personal digital assistant (PDA) or cellular telephone 954A, desktop computer 954B, laptop computer 954C, and/or automobile computer system 954N may communicate. Nodes 910 may communicate with one another. They may be grouped (not shown) physically or virtually, in one or more networks, such as Private, Community, Public, or Hybrid clouds as described hereinabove, or a combination thereof. This allows cloud computing environment 950 to offer infrastructure, platforms and/or software as services for which a cloud consumer does not need to maintain resources on a local computing device. It is understood that the types of computing devices 954A-N shown in FIG. 9 are intended to be illustrative only and that computing nodes 910 and cloud computing environment 950 can communicate with any type of computerized device over any type of network and/or network addressable connection (e.g., using a web browser).

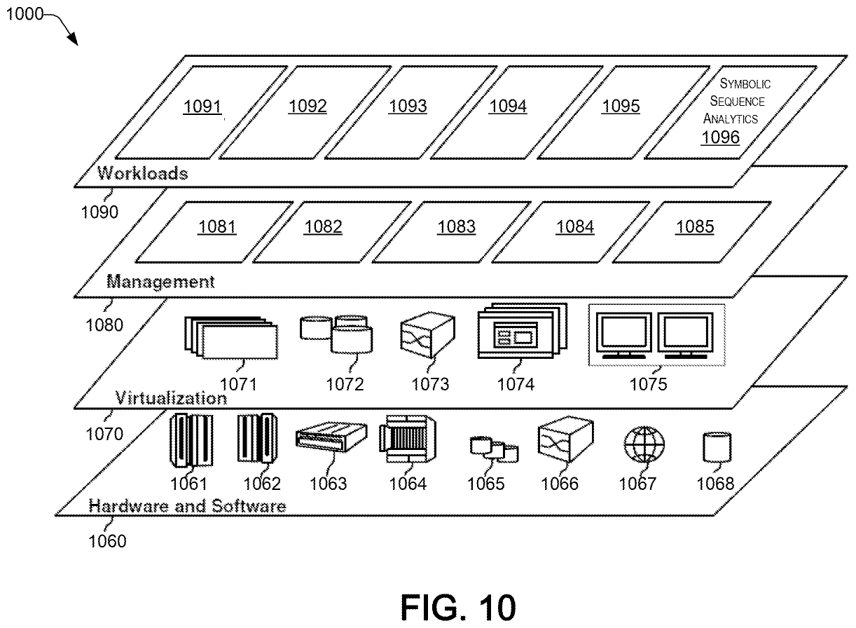

Referring now to FIG. 10, a set of functional abstraction layers provided by cloud computing environment 950 (FIG. 9) is shown. It should be understood in advance that the components, layers, and functions shown in FIG. 10 are intended to be illustrative only and embodiments of the disclosure are not limited thereto. As depicted, the following layers and corresponding functions are provided:

Hardware and software layer 1060 includes hardware and software components. Examples of hardware components include: mainframes 1061; RISC (Reduced Instruction Set Computer) architecture based servers 1062; servers 1063; blade servers 1064; storage devices 1065; and networks and networking components 1066. In some embodiments, software components include network application server software 1067 and database software 1068.

Virtualization layer 1070 provides an abstraction layer from which the following examples of virtual entities may be provided: virtual servers 1071; virtual storage 1072; virtual networks 1073, including virtual private networks; virtual applications and operating systems 1074; and virtual clients 1075.

In one example, management layer 1080 may provide the functions described below. Resource provisioning 1081 provides dynamic procurement of computing resources and other resources that are utilized to perform tasks within the cloud computing environment. Metering and Pricing 1082 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 1083 provides access to the cloud computing environment for consumers and system administrators. Service level management 1084 provides cloud computing resource allocation and management such that required service levels are met. Service Level Agreement (SLA) planning and fulfillment 1085 provide pre-arrangement for, and procurement of, cloud computing resources for which a future requirement is anticipated in accordance with an SLA.

Workloads layer 1090 provides examples of functionality for which the cloud computing environment may be utilized. Examples of workloads and functions which may be provided from this layer include: mapping and navigation 1091; software development and lifecycle management 1092; virtual classroom education delivery 1093; data analytics processing 1094; transaction processing 1095; and symbolic sequence analytics 1096, as discussed herein.

### CONCLUSION

The descriptions of the various embodiments of the present teachings have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

The components, steps, features, objects, benefits and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

Aspects of the present disclosure are described herein with reference to call flow illustrations and/or block diagrams of a method, apparatus (systems), and computer program products according to embodiments of the present disclosure. It will be understood that each step of the flowchart illustrations and/or block diagrams, and combinations of blocks in the call flow illustrations and/or block diagrams, can be implemented by computer readable program instructions.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the call flow process and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the call flow and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the call flow process and/or block diagram block or blocks.

The flowchart and block diagrams in the Figures illustrate the architecture, functionality, and operation of possible implementations of systems, methods, and computer program products according to various embodiments of the present disclosure. In this regard, each block in the call flow process or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or call flow illustration, and combinations of blocks in the block diagrams and/or call flow illustration, can be implemented by special purpose hardware-based systems that perform the specified functions or acts or carry out combinations of special purpose hardware and computer instructions.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A computer-implemented method to solve a machine learning task, the method comprising:
receiving a set of data having a set of nodes, a set of edges, and a set of relation types;
transforming a set of received samples from the set of data into a multiplexed graph, by creating a plurality of planes, each having the set of nodes and the set of edges, wherein each set of edges is associated with a given relation type from the set of relation types;
alternating message passing walks within and across the plurality of planes of the multiplexed graph using a graph neural network (GNN) layer, wherein:
the GNN layer has a plurality of units and each unit outputs an aggregation of two parallel sub-units; and
each sub-unit of the two parallel sub-units comprises a typed GNN layer that allows different permutations of connectivity patterns between intra-planar and inter-planar nodes; and
using a task-specific supervision to train a set of weights of the GNN for the machine learning task.

2. The computer-implemented method of claim 1, wherein for each sub-unit, a respective supra-walk matrix dictates that a set of information from the message passing walks is exchanged first within a planar connection followed by across a planar connection or first across a planar connection followed by within a planar connection.

3. The computer-implemented method of claim 1, wherein the machine learning task is a prediction of a graph level, an edge-level, and/or a node-level label of the set of provided samples.

4. The computer-implemented method of claim 1, wherein the aggregation of the sub-units is solved by a concatenation.

5. The computer-implemented method of claim 1, wherein the aggregation of the sub-units is solved by at least one of a minimum, a maximum, and/or an average.

6. The computer-implemented method of claim 1, wherein the GNN is one of a graph isomorphism network (GIN), a graph convolutional network (GCN), or a partial neighborhood aggregation network (PNA).

7. The computer-implemented method of claim 1, wherein the units are arranged serially in cascade.

8. A non-transitory computer readable storage medium tangibly embodying a computer readable program code having computer readable instructions to solve a machine learning task, that, when executed, the instructions cause a computer device to carry out a method comprising:
receiving a set of data having a set of nodes, a set of edges, and a set of relation types;
transforming a set of provided samples from the set of data into a multiplexed graph, by creating a plurality of planes that each have the set of nodes and the set of edges, wherein each set of edges is associated with a given relation type from the set of relation types;
alternating message passing walks within and across the plurality of planes of the multiplexed graph using a graph neural network (GNN) layer, wherein:
the GNN layer has a plurality of units;
each unit of the plurality of units outputs an aggregation of two parallel sub-units;
sub-units of the plurality of units comprise a typed GNN layer that allows different permutations of connectivity patterns between intra-planar and inter-planar nodes; and
using a task-specific supervision to train a set of weights of the GNN for the machine learning task.

9. The non-transitory computer readable storage medium of claim 8, wherein for each sub-unit, a respective supra-walk matrix dictates that a set of information from the message passing walks is exchanged first within a planar connection followed by across a planar connection or first across a planar connection followed by within a planar connection.

10. The non-transitory computer readable storage medium of claim 8, wherein the machine learning task is a prediction of a graph level, an edge-level, and/or a node-level label of the set of provided samples.

11. The non-transitory computer readable storage medium of claim 8, wherein the aggregation of the sub-units is solved by a concatenation.

12. The non-transitory computer readable storage medium of claim 8, wherein the aggregation of the sub-units is solved by at least one of a minimum, a maximum and/or an average.

13. The non-transitory computer readable storage medium of claim 8, wherein the GNN is one of a graph isomorphism network (GIN), a graph convolutional network (GCN), or a partial neighborhood aggregation network (PNA).

14. The non-transitory computer readable storage medium of claim 8, wherein the units are arranged serially in cascade.

15. A computing device comprising:
a processor;
a network interface coupled to the processor to enable communication over a network;
a storage device coupled to the processor; and
instructions stored in the storage device, wherein execution of the instructions by the processor configures the computing device to perform a method of solving a machine learning task comprising:
receiving a set of data with a set of nodes, a set of edges, and a set of relation types;
transforming a set of received samples from the set of data into a multiplexed graph, by creating a plurality of planes each having the set of nodes and the set of edges, wherein each set of edges is associated with a given relation type from the set of relation types;
alternating message passing walks within and across the plurality of planes of the multiplexed graph using a graph neural network (GNN) layer, wherein:
the GNN layer has a plurality of units and each unit outputs an aggregation of two parallel sub-units; and
each sub-unit of the two parallel sub-units comprises a typed GNN layer that allows different permutations of connectivity patterns between intra-planar and inter-planar nodes; and
using a task-specific supervision to train a set of weights of the GNN for the machine learning task.

16. The computing device of claim 15, wherein for each sub-unit a respective supra-walk matrix dictates that a set of information from the message passing walks is exchanged first within a planar connection followed by across a planar connection or first across a planar connection followed by within a planar connection.

17. The computing device of claim 15, wherein the machine learning task is a prediction of a graph level, an edge-level, and/or a node-level label of the set of provided samples.

18. The computing device of claim 15, wherein the aggregation of the sub-units is solved by a concatenation.

19. The computing device of claim 15, wherein the aggregation of the sub-units is solved by at least one of a minimum, a maximum, and/or an average.

20. The computing device of claim 15, wherein the GNN is one of a graph isomorphism network (GIN), a graph convolutional network (GCN), or a partial neighborhood aggregation network (PNA).
